(19) United States
(12) Patent Application Publication
(10) Pub. No.: US 2013/0225160 A1
(43) Pub. Date: Aug. 29, 2013

(54) BASE STATION AND INFORMATION RETRIEVAL METHOD OF MOBILE COMMUNICATION SYSTEM

(71) Applicants: Kosuke Fujino, Chiyoda-ku (JP); Kazunori Obata, Chiyoda-ku (JP); Hiroyuki Ishii, Chiyoda-ku (JP); Naoto Ookubo, Chiyoda-ku (JP)

(72) Inventors: Kosuke Fujino, Chiyoda-ku (JP); Kazunori Obata, Chiyoda-ku (JP); Hiroyuki Ishii, Chiyoda-ku (JP); Naoto Ookubo, Chiyoda-ku (JP)

(73) Assignee: NTT DOCOMO, INC., Tokyo (JP)

(21) Appl. No.: 13/883,945

(22) PCT Filed: Dec. 21, 2011
(86) PCT No.: PCT/JP2011/079740

§ 371 Date: May 7, 2013

(30) Foreign Application Priority Data
Dec. 24, 2010 (JP) 2010-288684

(51) Int. Cl. H04W 24/10

(52) U.S. Cl. CPC H04W 24/10
USPC 455/423

(57) ABSTRACT

A base station of a mobile communication system includes a receiver that receives capability information including information regarding plural frequencies which are measurable by the user equipment; an identifying unit that identifies, subsequent to allocation of radio resources to the user equipment, one or more different frequencies which are measurable by the user equipment and different from a frequency of a serving cell, among the plural frequencies in the capability information; and a transmitter that transmits a different frequency measurement command signal for commanding the user equipment to measure the identified one or more different frequencies or all the different frequencies, which are measurable by the user equipment, to the user equipment. The receiver receives a report signal indicating presence or absence of coverage for each of the one or more different frequencies from the user equipment that performs the measurement in response to the different frequency measurement command signal.

### TECHNICAL FIELD

The present invention relates to a base station and an information retrieval method of a mobile communication system.

### BACKGROUND ART

In this type of technical field, switching of user equipment to a neighboring cell in the same system or to a cell in another neighboring system, namely, redirection or redirect of the user equipment is frequently performed. By the redirection, load on a network can be distributed. Conventionally, a base station maintains a frequency of a cell (or a system) as station data, and the user equipment can be switched from a base station's own cell to the cell (or the system). A frequency f₁ of such a cell or a system is different from a frequency f₀ of the own cell. For example, at a particular timing, the base station commands the user equipment being served in the own cell to measure a frequency which is different from that of the own cell (different frequency measurement), thereby causing the user equipment to measure a reception level of the frequency f₁. The user equipment reports a measurement result to the base station. When the measurement result indicates existence of a base station that covers the frequency f₁, the base station of the own cell commands the user equipment to perform redirection to the frequency f₁. In response to this, radio resources between the base station of the own cell and the user equipment are released. Subsequent to the termination of the connection, the user equipment starts a connection procedure with the cell or the system of the different frequency f₁, and the user equipment switches to the cell or the system of the different frequency f₁. Japanese Unexamined Patent Publication No. 2004-312635 (Patent document 1) discloses such different frequency measurement and the like in a conventional system.

### SUMMARY OF THE INVENTION

### Problem to be Solved by the Invention

For the case of the above-described conventional method, the base station that commands the user equipment to perform the redirection is required to know the frequency of the destination of the redirection. That is because the frequency is to be specified for causing the user equipment to measure the presence or absence of the covering base station.

Because of the diversification of the communication services, there are large numbers of communications carriers, corporations, and operators that provide communication services. Further, there are many communication terminals (user equipment) that can operate in any of plural networks provided by the plural communications carriers. For a case of such a communication terminal, a destination of redirection is not limited to a network of a specific communications carrier, and the destination of the redirection may be a network of another communications carrier.

However, for a case of the conventional redirection method, the destination of the redirection, whose station data is maintained by the base station, is limited to an entity which exists within a network of a communications carrier that operates the base station. For example, for a communication terminal that is capable of communicating in a network A and a network B, a base station of a network A is unable to transmit a command signal for different frequency measurement, which enables redirection to a frequency of the network B of another operator. For example, the base station of the domestic network A does not maintain information regarding a network (especially, frequency information) of an operator in another country. Accordingly, the base station may not suitably recognize a different frequency with which the user equipment can be connected. A problem is that the number of candidates of the destination to which the communication terminal is redirected is limited to be smaller than the number of all the candidates to which the communication terminal can be redirected.

Whereas, a network configuration called a “femtocell” is being widely adopted. While a base station of a femtocell (femto base station) can be easily established by user's own hand, it is difficult for a normal base station (macro base station) to maintain information regarding all the femto base stations in the macrocell. For example, suppose that a communication terminal being served in a macrocell enters an area of a femtocell. Here, the communication terminal is assumed to be capable of communicating in both the macrocell and the femtocell. Since the macrocell base station does not maintain information regarding such a femtocell (especially, the frequency information), even in such a situation, the macrocell may not command the user equipment to perform redirection to the femtocell. In this case, the base station may not suitably recognize a different frequency with which the user equipment can be connected. The problem is that the number of the candidates of the destination to which the communication terminal is redirected is limited to be smaller than the number of all the candidates to which the communication terminal can be redirected.

Meanwhile, there is a function called an Automatic Neighbour Relation (ANR) such that, during a handover, for example, a macrocell base station collects information regarding another base station, thereby updating the macrocell base station's own station data. Basically, the ANR merely collects information within the network of the same communications carrier. The ANR does not collect another communications carrier's information. Further, the function of the ANR is used for collecting the information about the destination of the handover. The function of the ANR may not collect information for a purpose other then the purpose of the handover. Accordingly, even with the function of the ANR, the base station may not suitable recognize a different frequency with which the user equipment can be connected. The problem is that the number of the candidates of the destination to which the communication terminal is redirected is limited to be smaller than the number of all the candidates to which the communication terminal can be redirected. 3GPP TS36. 300 v10.1.0 (2010-09), 22.3.2a Automatic Neighbour Relation Function (Non-patent document 1) discloses the ANR.

An object of the present invention is to make it possible for a base station to recognize a different frequency with which user equipment can be connected.

### Means for Solving the Problem

According to one embodiment, there is provided a base station of a mobile communication system, the base station including

a receiver that receives capability information from user equipment, wherein the capability information includes at least information regarding plural frequencies that can be measured by the user equipment;

an identifying unit that identifies, subsequent to allocation of radio resources to the user equipment, one or more different frequencies among the plural frequencies in the capability information, wherein the plural frequencies can be measured by the user equipment, and the one or more different frequencies are different from a frequency of a serving cell; and

a transmitter that transmits a different frequency measurement command signal to the user equipment, wherein the different frequency measurement command signal is for commanding the user equipment to measure the identified one or more different frequencies or all the different frequencies that can be measured by the user equipment,

wherein the receiver receives a report signal from the user equipment that performs the measurement in response to the different frequency measurement command signal, the report signal indicating presence or absence of coverage for each of the one or more different frequencies.

### Effect of the Present Invention

According to one embodiment, the base station can specify a destination of the redirection to the user equipment. The destination of the redirection is suitable for the user equipment.

### BRIEF DESCRIPTION OF THE DRAWINGS

FIG. 1 is a conceptual diagram of a communication system;

FIG. 2 is a functional block diagram of a base station (eNode B);

FIG. 3 is a diagram showing an operating sequence in an embodiment; and

FIG. 4 is a diagram showing an operating sequence in a modified example.

### EMBODIMENTS FOR CARRYING OUT THE INVENTION

A base station according to one embodiment can find all the frequencies, which can be measured by user equipment, from capability information obtained by the user equipment. During different frequency measurement, the base station causes the user equipment to measure all the different frequencies. The user equipment reports a measurement result to the base station. Depending on necessity, the measurement result is reported to a switching center. By doing this, all the frequencies (different frequency bands) which can be detected by the user equipment can be made to be candidates for a destination of redirection. Accordingly, for the redirection, it is not mandatory to maintain information regarding frequencies of the destinations of the redirection as station data. Since the base station can find all the frequencies that can be detected by the user equipment and can retrieve their measurement results from the capability information of the user equipment, the base station can find which frequency can be used as the destination of the redirection. Since the base station can specify a suitable target of the redirection, concentration of load on a specific frequency band can be effectively avoided. Further, by managing a different frequency measurement result with location information of a user, an accurate area map including information regarding coverage of the different frequencies can be obtained. With this, communication services can further be improved.

An embodiment of the present invention is explained from the following viewpoints.

1. System

2. Base station

3. Operation example

4. Modified example

### Embodiment 1

<1. System>

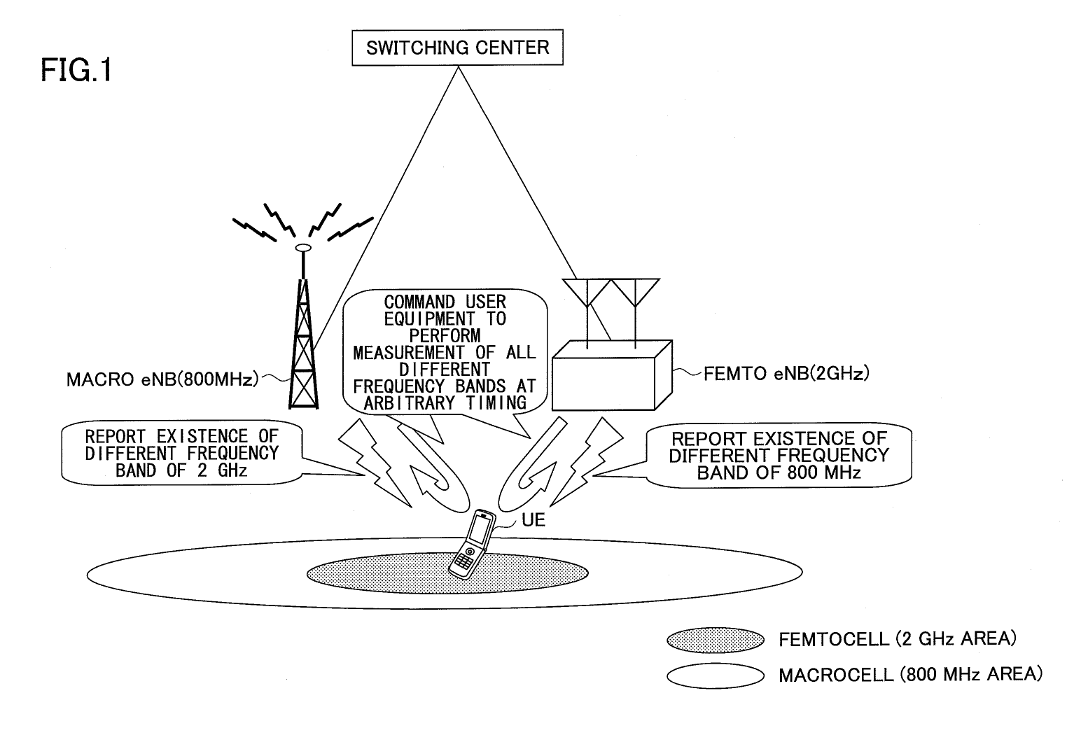

FIG. 1 shows a conceptual diagram of a communication system that can be used in an embodiment. A macrocell base station (macro eNB) and a femtocell base station (femto base station, femto eNB) are connected to a switching center. As an example, the switching center can communicate with the macro eNB and the femto eNB by using an Internet protocol (IP). A frequency band of the macrocell is 800 MHz. A frequency band of the femtocell is 2 GHz. The femtocell is included in the macrocell. However, the entire femtocell or a part of the femtocell may not be included in the macrocell. Specific numerical values of the number of the cells and the frequencies are merely examples, and any other suitable numerical values may be used. When the user equipment (UE) is served by the macrocell or the femtocell, the user equipment (UE) can perform radio communication.

In the embodiment, a reference symbol (E-UTRAN NodeB: eNB) in the 3GPP standard specifications is used for indicating the base station. However, the present invention is not limited to systems based on the long term evolution (LTE) scheme or the E-UTRAN scheme, and the present invention may be used for any suitable communication systems.

The switching center is connected to the base stations (macro eNB and femto eNB) through an S1 interface and the like. The switching center is, as an example, a switching center in an Evolved Packet Core (EPC), and the switching center includes at least a control element (MME: Mobility Management Entity) for a circuit-switched network and a control element (SGSN: Serving GPRS Support Node) for a packet-switched network. Specifically, the switching center performs processes regarding mobility management in a network; tracking area (a location registration area) list management; selection of a gateway (GW) for a packet data network (PDN); selection of a serving gateway (GW); selection of a switching center during a handover; roaming; authentication; bearer management; subscriber information management; mobility management; call originating and receiving control; billing control; and QoS control, for example.

The macrocell base station (macro eNB) relays communication between the user equipment being served and the switching center. For example, the macro eNB is a base station in a mobile communication system based on the LTE scheme. Here, the base station may be referred to as an “access point AP.” The macro eNB performs, for example, radio resource management; an IP header compression and encryption process; routing of user plane data; and scheduling of paging messages and broadcast information.

The femtocell base station (femto eNB) also relays communication between the user equipment being served and the switching center. The femtocell covers a very narrow area, compared to the macrocell. For example, while a radius of the macrocell is several kilometers, a radius of the femtocell is several tens of meters. The femtocell is usually installed in an indoor environment such as inside of a house or an office. However, the femtocell may be installed in an outdoor environment. The femto eNB also performs, for example, radio resource management; an IP header compression and encryption process; routing of user plane data; and scheduling of paging messages and broadcast information. The user equipment (UE) or a mobile station (UE) is user equipment that can perform communication both in the macro cell and the femto cell. Specifically, the user equipment may be a mobile phone, an information terminal, a smart phone, a personal digital assistant (PDA), or a mobile computer, for example. However, the user equipment is not limited to these.

<2. Base Station>

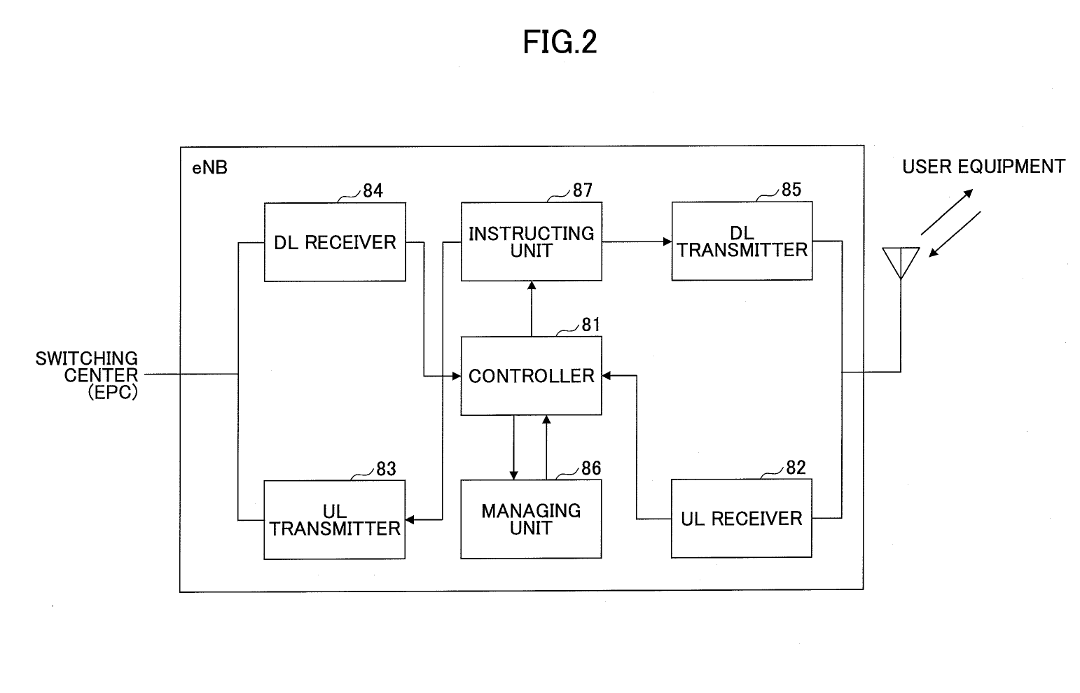

FIG. 2 shows a base station (eNB) that can be used in the embodiment. This base station (eNB) may be used as a macro eNB or a femto eNB. FIG. 2 schematically shows elements which are especially related to the embodiment, among various functions included in the base station (eNB). FIG. 2 depicts a controller 81; an uplink receiver 82; an uplink transmitter 83; a downlink receiver 84; a downlink transmitter 85; a managing unit 86; and an instructing unit 87.

The controller 81 controls operations of various types of functional elements in the base station (eNB).

The uplink (UL) receiver 82 receives an uplink radio signal transmitted from the user equipment (UE). For example, the UL receiver 83 receives a UE capability enquiry acknowledgement signal; a confidential authentication command acknowledgement signal; a line setting/measurement command acknowledgement signal; and a measurement result report signal from the user equipment (UE).

The uplink (UL) transmitter 83 transmits a signal to be reported to the switching center. This signal is transmitted through an S1 interface. For example, the UL transmitter 83 transmits a line setting request signal; a mobile station capability report signal; and a line setting acknowledgement signal to the switching center.

A downlink (DL) receiver 84 receives a signal from the switching center. This signal is also transmitted through the S1 interface. For example, the DL receiver 84 receives a line setting command signal.

The downlink (DL) transmitter 85 wirelessly transmits a downlink signal to the user equipment (UE). For example, the DL transmitter 85 transmits a UE capability enquiry signal, a confidential authentication command signal, and a line setting/measurement command signal to the user equipment (UE).

The managing unit 86 manages radio resources, identifiers, security information, and the like. The managing unit 86 suitably provides information to the controller 81.

The instructing unit 87 generates a message or a signal to be transmitted to the switching center and/or the user equipment (UE), and the instructing unit 87 provides the message or the signal to the UL transmitter 83 and/or the DL transmitter 85.

Especially, for the case of the embodiment, the controller 81 and the managing unit 86 cooperate, and thereby one or more different frequencies are identified in the capability information, among plural frequencies that can be measured by the user equipment. The one or mode different frequencies are different from the frequency of the serving cell of the user equipment. As described later, the capability information includes category information of the user equipment; information indicating a frequency band in which the user equipment can perform communication; and security information, for example. The DL transmitter 85 transmits a different frequency measurement command signal to the user equipment. The different frequency measurement command is for commanding the user equipment to perform the different frequency measurement with respect to the identified one or more different frequencies.

<3. Operation Example>

Hereinafter, there are explained operations which are performed among the user equipment (UE), the macro or femto base station (eNB), and the switching center. The base station (eNB) may be a macro eNB or a femto eNB. One of the macro eNB and the femto eNB, or both the macro eNB and the femto eNB perform the following operations.

For example, the following procedure is started after the user turns on a power supply, or when a state switches from an idle mode (a standby mode) to an active mode.

At step S301, the user equipment (UE) transmits a message that requests call connection to the base station (eNB), and the base station (eNB) responds to it. By doing this, RRC connection is established (RRC Connection setting).

At step S303, the base station (eNB) transmits a line setting request signal to the switching center (Initial UE Message). The line setting request signal is for requesting setting of a line.

At step S305, the switching center transmits a line setting command signal to the base station (eNB) (Initial Context Setup Request). The line setting command signal is for commanding to establish the line.

At step S307, the base station (eNB) transmits a UE capability enquiry signal to the user equipment (UE). The UE capability enquiry signal is for requesting the capability information of the user equipment (UE). The capability information includes, for example, category information of the user equipment, information indicating the frequency band in which the user equipment can perform communication, and security information (UE Capability Enquiry).

At step S309, the user equipment (UE) transmits a UE capability enquiry acknowledgement signal to the base station (eNB). The UE capability enquiry acknowledgement signal includes the capability information. For example, suppose that the user equipment is currently served by a cell of a frequency f₀, and that the user equipment can perform communication with frequencies f₁, f₂, or f₃. The frequencies f₁, f₂, and f₃ are different from the frequency f₀. In this case, the capability information included in the UE capability enquiry acknowledgement signal indicates that the user equipment can perform communication with the frequencies f₁, f₂, and f₃. The capability information includes information regarding all the frequencies with which the user equipment can perform communication.

At step S311, the base station (eNB) transmits a UE capability report signal to the switching center. The UE capability report signal includes the capability information.

At step S313, the base station (eNB) transmits a confidential authentication command signal to the user equipment (UE) (Security Mode Command). The confidential authentication command signal includes, for example, information regarding a key that is used for encrypting communication.

At step S315, the base station (eNB) transmits a line setting/measurement command signal to the user equipment (UE) (RRC Connection Reconfiguration). The line setting/measurement command signal is for allocating radio resources.

At step S317, the user equipment (UE) transmits a confidential authentication command acknowledgement signal to the switching center (Security Mode Complete). The confidential authentication command acknowledgement signal is for responding to the confidential authentication command signal.

At step S319, the user equipment (UE) transmits a line setting/measurement command acknowledgement signal to the switching center (RRC Connection Reconfiguration Complete). The line setting/measurement command acknowledgement signal is for responding to the line setting measurement command signal.

At step S321, the base station (eNB) transmits a line setting acknowledgement signal to the switching center. The line setting acknowledgement signal is for responding to the line setting command signal, which is received at step S305. Subsequent to step S321, the user equipment (UE) can transmit and receive user data. In this case, an operating mode is an active mode or an active state.

At step S323, the base station (eNB) transmits a line setting/measurement command signal to the user equipment (UE), so that the user equipment (UE) performs the different frequency measurement and reports a measurement result (RRC Connection Reconfiguration). The line setting/measurement command signal for commanding the user equipment (UE) to perform the different frequency measurement specifies the frequencies for which the user equipment (UE) is to perform the measurement. When the base station can identify suitable different frequencies from the capability information of the user equipment, the different frequency measurement is commanded by concretely specifying the frequencies. Whereas, when the base station fails to identify such suitable different frequencies, the user equipment may be commanded to measure all the measurable frequencies, without specifying concrete frequencies. Alternatively, the line setting/measurement command signal for commanding to perform the different frequency measurement may indicate that the user equipment is to measure all the measureable frequencies, without specifying concrete frequencies, regardless of whether the base station can identify the suitable different frequencies. For the case of the embodiment, the line setting/measurement command signal specifies all the different frequencies that can be measured by the user equipment (UE). Suppose that the capability information of the user equipment (UE) indicates that communication can be performed with the frequencies f₀, f₁, f₂, and f₃. Here, the frequency f₀ is assumed to be the frequency of the currently serving cell. In this case, the line setting/measurement signal that requests the different frequency measurement indicates that the measurement is to be performed for the frequencies f₁, f₂, and f₃, which are different from f₀.

At step S325, the user equipment (UE) transmits a line setting/measurement command acknowledgement signal to the base station (eNB) (RRC Connection Reconfiguration Complete). The line setting/measurement command acknowledgement signal is for responding to the line setting/measurement command signal, which requests the different frequency measurement.

At step S326, the user equipment (UE) performs the different frequency measurement for each of the frequencies f₁, f₂, and f₃. The line setting/measurement command signal that requests the different frequency measurement specifies the time at which the measurement is to be performed, in addition to the frequencies to be measured. The time interval for performing the different frequency measurement is a time interval which is referred to as the “measurement gap.” During the constant time period which is defined to be the measurement gap, the user equipment (UE) switches to the specified frequency (e.g., f₁), measures a reception level, determines presence or absence of the coverage, and returns to the original frequency f₀. The reception level can be measured in terms of any suitable quantity. For example, the reception level may be expressed in terms of received power; electric field strength RSSI; desired wave received power RSCP; a path loss; a SNR; a SIR; or E_{C}/N₀. The presence or absence of the coverage may be determined based on whether the reception level exceeds a threshold value.

At step S327, the user equipment (UE) transmits a measurement result report signal to the base station (eNB) (Measurement Report). The measurement result report signal includes a measurement result of the different frequency measurement. As an example, the measurement result may be expressed by the presence or absence of the coverage for each of the frequencies. For example, suppose that the reception levels exceed the threshold value for the frequencies f₁ and f₂, and that the reception level is less than the threshold value for the frequency f₃. In this case, the measurement result may include information indicating that the coverage exists for the frequencies f₁ and f₂. The measurement result may not include information indicating that the coverage does not exist for the frequency f₃. Since the base station (eNB) maintains information regarding the frequencies for which measurement is performed, the base station can determined that the coverage does not exist for the frequency for which there are no reports.

At step S328, the base station (eNB) transmits a report signal including the measurement result to the switching center. The timing of transmitting the report signal including the measurement result may be any timing, provided that the timing is subsequent to the step S372 and prior to the step S329.

At step S329, the base station (eNB) transmits a release request signal to the switching center (UE Context Release Request). The release request signal is to request redirection of the user equipment. The redirection may be performed when the base station (eNB) desires to distribute the load. Alternatively, the redirection may be performed in response to a command from the switching center.

At step S331, the switching center transmits a release response signal for responding to the release request signal (UE Context Release Command).

At step S333, the base station (eNB) transmits a redirection command signal to the user equipment (UE). The redirection command signal is for commanding the user equipment (UE) to perform redirection to the cell or the system of the specific frequency (e.g., f₁). In response to this, the user equipment (UE) and the base station (eNB) release the radio resources, and disconnect the RRC connection. The user equipment (UE) starts a procedure to be connected to the cell or the system of the frequency f₁, which is indicated by the redirection command signal. In this manner, the redirection to the cell or the system of f₁, which is different from the frequency f₀, is completed.

For the example shown in FIG. 1, by performing the above-described operations by the base station of the macrocell (macro eNB), the macro eNB can recognize the existence of the femtocell of 2 GHz, which is different from 800 MHz, without relying on the frequency information of other cells, which is maintained as the station data. With this, the macro eNB can specify the femtocell of 2 GHz, as a destination of the redirection. Alternatively, the base station of the femtocell (femto eNB) may perform the above-described operations. In this case, the femto eNB can recognize the existence of the macrocell of 800 MHz, which is different from 2 GHz. With this, the femto eNB can specify the macrocell of 800 MHz, as a destination of the redirection. Accordingly, this embodiment is advantageous for both the macrocell and the femtocell. Especially, the base station of the macrocell does not maintain information regarding what types of femtocells exist in its own cell. Thus, the macro eNB according to the embodiment is particularly advantageous in a point that it can find a frequency of a femtocell, which is usually unknown.

For the case of the embodiment, subsequent to step S321, a command is provided at least once, so that the user equipment (UE) performs the different frequency measurement. Conventionally, an instruction for different frequency measurement is made for the purpose of a handover when a reception level degrades in the user equipment (UE). Whereas, in the embodiment, the different frequency measurement is requested, irrespective of such a situation. From the viewpoint that the base station (eNB) and the switching center can accurately find frequencies to which the user equipment (UE) can be redirected, it is preferable that the instruction for the different frequency measurement be made when the reception level of the user equipment (UE) is good. The request for the different frequency measurement at step S323 is made at least once. The request may be made more than two times. For a case where the location of the user equipment (UE) does not significantly change regardless of elapsed time, the different frequency measurement may be made only once at step S323. However, for a case where the location of the user equipment (UE) significantly changes, or a case where a communication environment of the user significantly changes over time, it is preferable that a result of the different frequency measurement be reported to the base station (eNB) and the switching center periodically or depending on necessity. For example, in accordance with the command, which is shown at step S322, from the switching center, the base station (eNB) may transmit the line setting/measurement command signal that requests the different frequency measurement to the user equipment (UE).

<4. Modified Example>

According to the embodiment, all the candidates for the destination of the redirection can be detected by causing the user equipment (UE) to perform the different frequency measurement for all the frequencies, which can be measured by the user equipment (UE). By doing this, the suitable destination of the redirection can be reported to the user equipment (UE) during the redirection, and thereby the concentration of the load on a specific frequency band can be avoided, and a load distribution effect on the network can be demonstrated. Further, by finding the presence or absence of the coverage for the frequencies based on the result of the different frequency measurement, an area map may be made. In this case, the base station (eNB) or the switching center is required to find the location accurately where the different frequency measurement is performed. In this modified example, in addition to the result of the different frequency measurement, location information of the user equipment (UE) is reported to the base station (eNB) and the like. As for the procedure to obtain the location information of the user equipment (UE), as an example, the LTE Positioning Protocol (LPP) or the LTE Positioning Protocol Annex (LPPa) may be utilized. 3GPP TS36. 455 v9. 3.0 (2010-09) (Non-patent document 2) discloses the LPP and the LPPa.

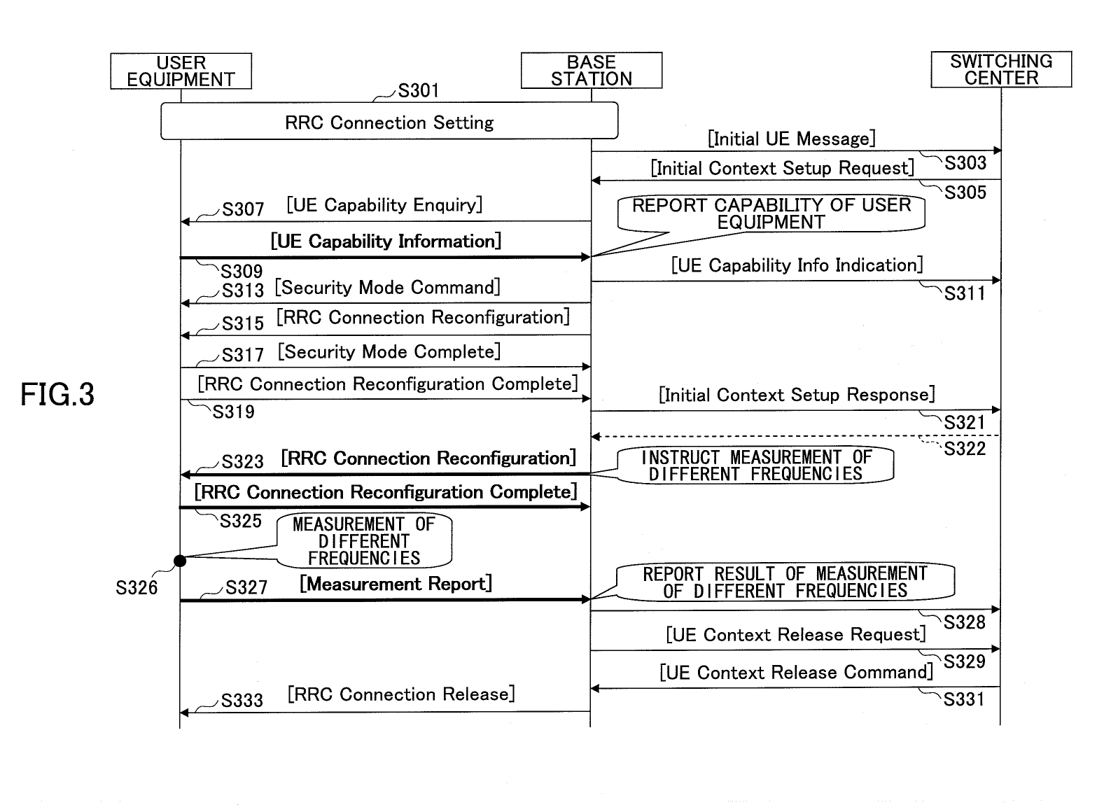

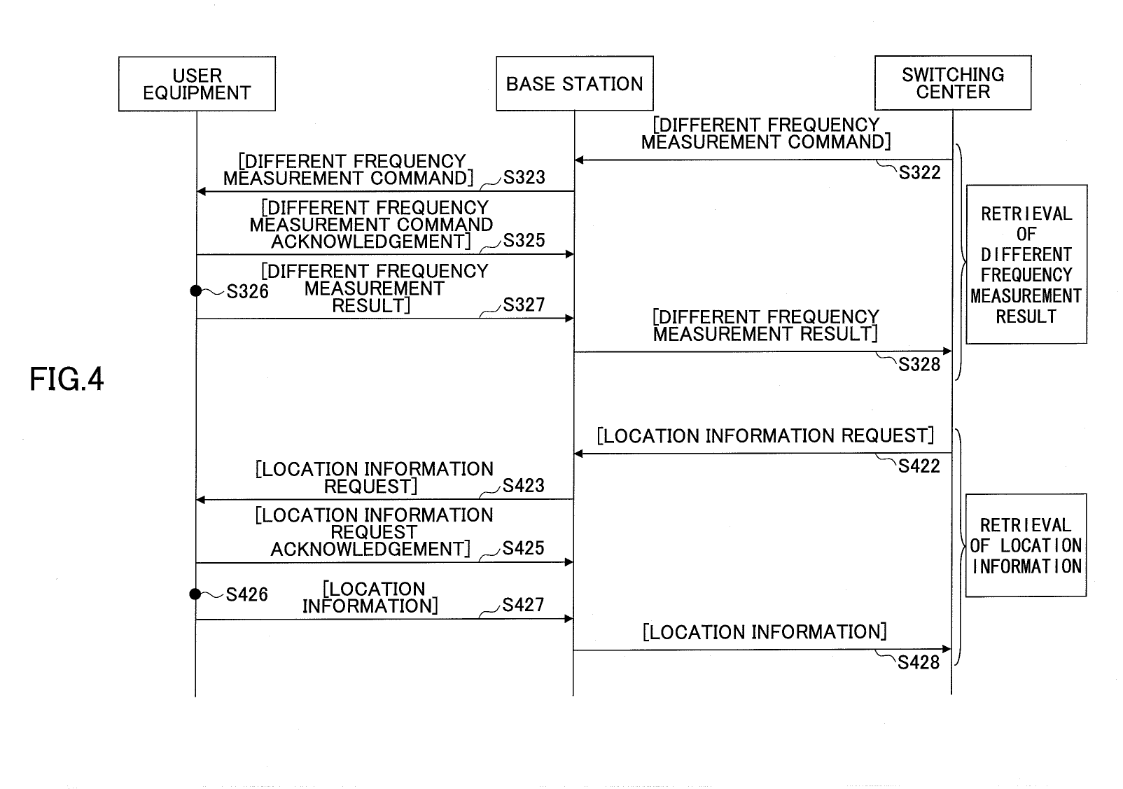

FIG. 4 shows an operation example in the modified example. FIG. 4 shows operations after the user equipment (UE) is enabled to perform radio communication by step S321 shown in FIG. 3. In the figure, the same reference symbols or reference numerals are used for the steps that are explained in FIG. 3.

At step S322, the switching center transmits a signal that commands performing the different frequency measurement to the base station (eNB).

At step S323, the base station (eNB) transmits a line setting/measurement command signal to the user equipment (UE), so that the user equipment (UE) performs the different frequency measurement and reports a measurement result (RRC Connection Reconfiguration).

At step S325, the user equipment (UE) transmits a line setting/measurement command acknowledgement signal to the base station (eNB) (RRC Connection Reconfiguration Complete). The line setting/measurement command acknowledgement signal is for responding to the line setting/measurement command signal that requests the different frequency measurement.

At step S326, the user equipment (UE) performs the different frequency measurement for each of the specified frequencies.

At step S327, the user equipment (UE) transmits a measurement result report signal including a measurement result of the different frequency measurement to the base station (eNB) (Measurement Report).

At step S328, the base station (eNB) transmits a report signal including the measurement result to the switching center.

The steps so far are already explained in FIG. 3.

At step S422, the switching center transmits a signal that requests location information of the user equipment (UE) to the base station (eNB).

At step S423, the base station (eNB) transmits a line setting/measurement command signal to the user equipment (UE), so that the user equipment (UE) reports the location information.

At step S425, the user equipment (UE) transmits a line setting/measurement command acknowledgement signal to the base station (eNB). The line setting/measurement command acknowledgement signal is for responding to the request for the location information.

At step S426, the user equipment (UE) obtains the location information. For example, for a case where the user equipment (UE) includes a GPS receiver for the Global Positioning System (GPS), the location information is obtained from a satellite signal received by the GPS receiver. Alternatively, the user equipment (UE) may retrieve the location information through a network.

At step S427, the user equipment (UE) transmits a report signal including the location information to the base station (eNB).

At step S428, the base station (eNB) transmits a report signal including the location information to the switching center.

Similar to step S323, the signal at step S423 may be made by the line setting/measurement command signal (RRC Connection Reconfiguration). Similar to step S325, the signal at step S425 may be made by the line setting/measurement command acknowledgement signal (RRC Connection Reconfiguration Complete). Similar to step S327, the signal at step S427 may be made by the measurement result report signal (Measurement Report). Namely, the step of retrieving the location information can be performed similar to the step of obtaining the different frequency measurement.

The base station (eNB) and the switching center can manage the result of the different frequency measurement together with the accurate location information of the user equipment (UE) by a database, thereby obtaining an accurate area map.

Here, it is explained that the steps of obtaining the location information from step S422 to step S428 are performed after the steps of obtaining the result of the different frequency measurement from step S322 to step S328. However, this is not mandatory. All the steps of obtaining the location information or a part of the steps of obtaining the location information may be performed prior to the steps of obtaining the result of the different frequency measurement, subsequent to the steps of obtaining the result of the different frequency measurement, or in the middle of the steps of obtaining the result of the different frequency measurement. Alternatively, the process of obtaining the result of the different frequency measurement and the process of obtaining the location information may be performed simultaneously. In this case, the command for the different frequency measurement and the request for the location information are sent to the user equipment by a single message, and a message including both the result of the different frequency measurement and the location information is transmitted from the user equipment to the base station.

Hereinabove, the present invention is explained by referring the specific embodiments.

However, the embodiments are merely illustrative, and variations, modifications, alterations, and substitutions could be conceived by those skilled in the art. For example, the present invention may be applied to any suitable mobile communication systems that cause user equipment to perform different frequency measurement. For example, the present invention may be applied to a W-CDMA system, an HSDPA/HSUPA based W-CDMA system; an LTE system; an LTE-Advanced system; an IMT-Advanced system; a WiMAX system; and a Wi-Fi system. In order to facilitate understanding of the invention, the explanation is made while using specific examples of numerical values. However, these numerical values are simply illustrative, and any other appropriate values may be used, except as indicated otherwise. The separations of the embodiments or the items are not essential to the present invention. Depending on necessity, subject matter described in two or more items may be combined and used, and subject matter described in an item may be applied to subject matter described in another item (provided that they do not contradict). For the convenience of explanation, the devices according to the embodiments of the present invention are explained by using functional block diagrams. However, these devices may be implemented in hardware, software, or combinations thereof. The software may be prepared in any appropriate storage medium, such as a random access memory (RAM), a flash memory, a read only memory (ROM), an EPROM, an EEPROM, a register, a hard disk drive (HDD), a removable disk, a CD-ROM, a database, a server, and the like. The present invention is not limited to the above-described embodiments, and various variations, modifications, alterations, substitutions and so on are included, without departing from the spirit of the present invention.

The present international application claims priority based on Japanese Patent Application No. 2010-288684, filed on Dec. 24, 2010, the entire contents of Japanese Patent Application No. 2010-288684 are hereby incorporated by reference.

### LIST OF REFERENCE SYMBOLS

81: Controller
82: Uplink (UL) receiver
83: Uplink (UL) transmitter
84: Downlink (DL) receiver
85: Downlink (DL) transmitter
86: Managing unit
87: Instructing unit

1. A base station of a mobile communication system comprising:
a receiver that receives capability information from user equipment, wherein the capability information includes at least information regarding plural frequencies that can be measured by the user equipment;
an identifying unit that identifies, subsequent to allocation of radio resources to the user equipment, one or more different frequencies among the plural frequencies in the capability information, wherein the plural frequencies can be measured by the user equipment, and the one or more different frequencies are different from a frequency of a serving cell; and
a transmitter that transmits a different frequency measurement command signal to the user equipment, wherein the different frequency measurement command signal is for commanding the user equipment to measure the identified one or more different frequencies or all the different frequencies that can be measured by the user equipment,
wherein the receiver receives a report signal from the user equipment that performs the measurement in response to the different frequency measurement command signal, the report signal indicating presence or absence of coverage for each of the one or more different frequencies. 35

2. The base station according to claim 1,
wherein the transmitter transmits a command signal to the user equipment, wherein the command signal is for commanding the user equipment to perform redirection to any one of the frequencies for which the coverage exists.

3. The base station according to claim 1,
wherein the transmitter transmits a request signal for requesting location information of the user equipment, and
wherein the receiver receives an acknowledgement signal including the location information.

4. The base station according to claim 1, further comprising:
a switching center transmitter that transmits a content of the report signal to a switching center.

5. An information retrieval method of a mobile communication system, the method comprising:
receiving capability information from user equipment, wherein the capability information includes at least information regarding plural frequencies that can be measured by the user equipment;
identifying, subsequent to allocation of radio resources to the user equipment, one or more different frequencies among the plural frequencies in the capability information, wherein the plural frequencies can be measured by the user equipment, and the one or more different frequencies are different from a frequency of a serving cell;
transmitting a different frequency measurement command signal to the user equipment, wherein the different frequency measurement command signal is for commanding the user equipment to measure the identified one or more different frequencies or all the different frequencies that can be measured by the user equipment; and
receiving a report signal from the user equipment that performs the measurement in response to the different frequency measurement command signal, the report signal indicating presence or absence of coverage for each of the one or more different frequencies.
